(19) United States
(12) Patent Application Publication
(10) Pub. No.: US 2026/0005454 A1
(43) Pub. Date: Jan. 1, 2026

(54) MULTI-DIRECTIONAL TERMINAL BLOCK AND METHOD OF MAKING

(71) Applicant: Advanced Energy Industries, Inc., Denver, CO (US)

(72) Inventors: Paolo Chavez, Pasig City (PH); Mark Anthony Porciuncula, Eastwood (PH); Jesus Bravo, Caloocan (PH)

(21) Appl. No.: 18/760,228

(22) Filed: Jul. 1, 2024

(51) Int. Cl. H01R 9/24

(52) U.S. Cl. CPC H01R 9/2416

(57) ABSTRACT

A terminal block comprises a terminal housing having a plurality of walls forming a plurality of terminal openings and a plurality of terminals, each terminal positioned in a respective terminal opening of the plurality of terminal openings. Each terminal of the plurality of terminals is electrically conductive and includes a front portion having a front surface having a first fastener opening formed therein, a first side surface having a second fastener opening formed therein, and a rear surface opposite the front surface. Each terminal also includes a rear portion extending from the rear surface and an adaptor. The rear portion has an adaptor fastener opening formed therein, and the adaptor is coupled to the rear portion via an adaptor fastener positioned within the adaptor fastener opening.

### TECHNICAL FIELD

Aspects of the disclosure relate to electrical components and, more particularly, to apparatus for coupling electrical paths together.

### BACKGROUND

A power supply unit (PSU) is an electrical device that supplies electric power to output load. Indeed, PSUs typically have a power input connection, which receives energy in the form of electric current from a source, and one or more power output connections that deliver current to the load. The primary function of a PSU is to convert electric current from a source to a correct voltage, current, and frequency to power a load. Indeed, a PSU may perform a variety of functions, such as, but not limited to, power conversion, alternating current to direct current (AC-DC) or DC-DC conversion, adjusting voltage levels, and providing backup power during power grid outages. A PSU system typically includes multiple power sources (or PSUs) that provide power and power management functionality including load current sharing among the multiple power sources.

Various strategies exist for coupling input power to the PSU for power conversion. In one example, a power blade type input connector coupled to the power supply may receive a mating connector from an input power source to supply power to the PSU. Often, the power blade type input connector is a unique part specifically designed for the PSU and requires a specialty connector from the input power source. Both the unique input connector and specialty connector increase manufacturing costs. Alternatively, a barrier type terminal block may be used on the PSU for receiving cables providing the input power. The barrier type terminal block can be connected to a printed circuit board using its own footprint layout but has a limited orientation for coupling cables from the input power source thereto.

### SUMMARY

In accordance with one aspect of the present disclosure, a terminal block comprises a terminal housing having a plurality of walls forming a plurality of terminal openings and a plurality of terminals, each terminal positioned in a respective terminal opening of the plurality of terminal openings. Each terminal of the plurality of terminals is electrically conductive and includes a front portion having a front surface having a first fastener opening formed therein, a first side surface having a second fastener opening formed therein, and a rear surface opposite the front surface. Each terminal also includes a rear portion extending from the rear surface and an adaptor. The rear portion has an adaptor fastener opening formed therein, and the adaptor is coupled to the rear portion via an adaptor fastener positioned within the adaptor fastener opening.

In accordance with another aspect of the present disclosure, a multi-position terminal block comprises a housing having a pair of openings formed via a plurality of walls, a first terminal positioned in a first opening of the pair of openings, and a second terminal positioned in a second opening of the pair of openings. Each of the first and second terminals is electrically conductive and comprises a front portion and a rear portion. The front portion has a front surface having a first fastener opening formed therein, a first side surface having a second fastener opening formed therein, and a rear surface opposite the front surface. The rear portion extends from the rear surface and has a wire fastener opening formed in a first surface of the rear portion. A rear surface of the rear portion has a wire opening formed therein communicating with the wire fastener opening.

In accordance with another aspect of the present disclosure, a method of making a multi-position terminal block comprises forming a housing comprising a plurality of walls forming a plurality of terminal openings. The method also comprises inserting, into each of the terminal openings, a terminal having a front-facing surface having first and second fastener openings formed therein, a top-facing surface having a third fastener opening formed therein, a first rear-facing surface opposite a first portion of the front-facing surface, a second rear-facing surface opposite a second portion of the front-facing surface and having a wire opening formed therein communicating with the second fastener opening, a first side-facing surface, and a second side-facing surface opposite one another and having an adapter fastener opening formed between the first and second side-facing surfaces.

### BRIEF DESCRIPTION OF THE DRAWINGS

The drawings illustrate embodiments presently contemplated for carrying out the invention.

In the drawings:

FIG. 1 is an orthogonal view of a multi-directional terminal block according to an embodiment.

FIG. 2 is an exploded view of the terminal block of FIG. 1 according to an embodiment.

FIG. 3 is an exploded view of a terminal of the terminal block of FIG. 1 according to an embodiment.

FIG. 4 is an orthogonal view of the terminals of the terminal block of FIG. 1 according to another embodiment.

FIG. 5 is an exploded view illustrating wire connections to the terminal of FIG. 2 according to an embodiment.

FIG. 6 is an exploded view illustrating wire connections to the terminal of FIG. 2 according to another embodiment.

FIGS. 7 and 8 illustrate snap connections of the terminals and housing of the terminal block of FIG. 1 according to an embodiment.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

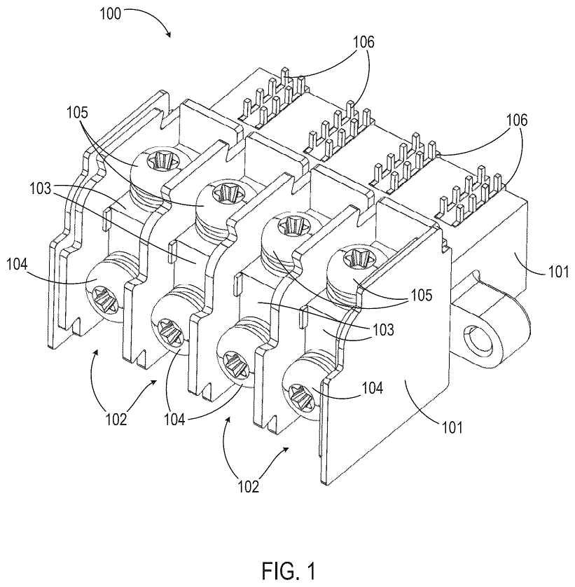

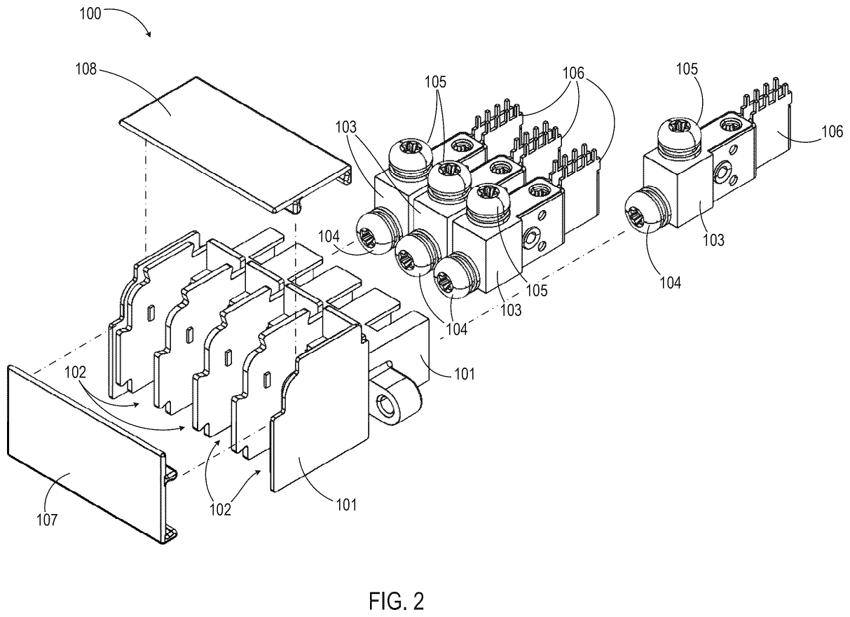

FIG. 1 is an orthogonal view of a multi-directional terminal block 100 according to an embodiment. FIG. 2 illustrates an exploded view of the terminal block 100 according to an embodiment. Referring to FIGS. 1 and 2, the terminal block 100 includes a terminal housing 101 having a plurality of terminal openings 102 for receiving terminals 103 therein. As illustrated, the terminal block 100 incudes openings terminal opening 102 for four terminals 103. However, it is contemplated that fewer or more than four terminals/openings may be constructed according to the teachings of this disclosure. Each terminal 103 includes a pair of wire fasteners 104, 105 and an optional adaptor 106 coupled thereto.

As shown in FIG. 2, a removable front cover 107 may be attached to a front of the terminal housing 101 to shield the wire fasteners 104 from manipulation. A removable top cover 108 may be attached to a top of the terminal housing 101 to protect the wire fasteners 105. The covers 107, 108 may be made of a material such as plastic and may be see-through or opaque as desired. The terminals 103 are electrically conductive, and to prevent electrical conduction between any of the terminals 103, the terminal housing 101 is constructed of an electrically insulative material such as plastic. Accordingly, when positioned within the terminal housing 101 as shown in FIG. 1, each terminal 103 is electrically insulated from the other terminals 103.

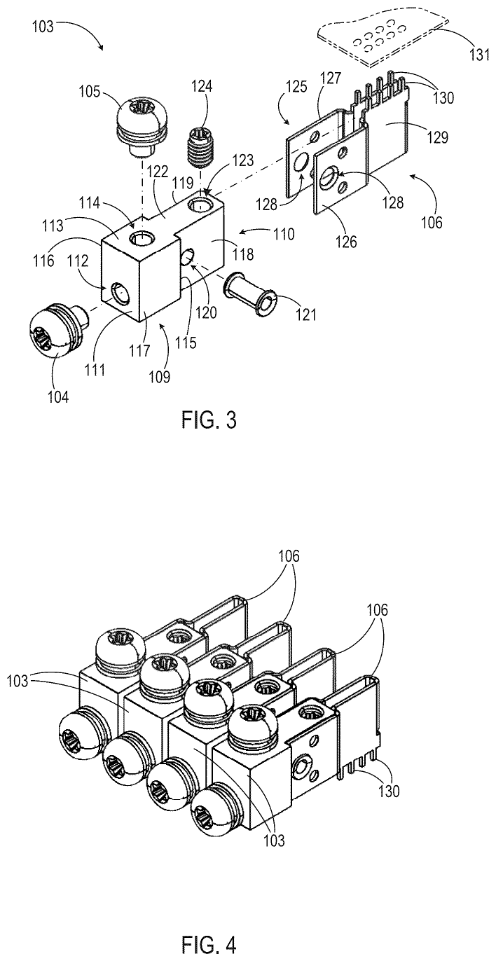

FIG. 3 is an exploded view of a terminal 103 of the terminal block of FIG. 1 according to an embodiment. The terminal 103 includes a front portion 109 and a rear portion 110. The front portion 109 includes a front surface 111 having a fastener opening 112 formed therein. The fastener opening 112 is configured to allow the wire fastener 104 to be inserted therein. For example, the wire fastener 104 may be a screw with a threaded interface configured to engage a threaded interface of the wire fastener 104. A side surface 113 such as a top side surface of the front portion 109 also has a fastener opening 114 formed therein to allow the wire fastener 105 to be inserted therein. Similar to the wire fastener 104, the wire fastener 105 may be a screw-type fastener. The front portion 109 further includes a rear surface 115 opposite the front surface 111. The rear portion 110 extends from the rear surface 115. The front portion 109 further includes opposite side surfaces 116, 117. The front surface 111 is orthogonal to the side surfaces 113, 116, and 117 and is parallel with the rear surface 115.

The rear portion 110 includes a pair of opposite side surfaces 118, 119 through which an adaptor fastener opening 120 is formed. The adaptor fastener opening 120 allows an adaptor fastener 121 to be inserted therein to couple the adaptor 106 to the rear portion 110. In one embodiment, the adaptor fastener 121 is a rivet. However, other types of adaptor fasteners are also contemplated herein. A side surface 122 such as a top side surface of the rear portion 110 has a wire fastener opening 123 formed therein to allow a wire fastener 124 to be inserted therein. While the side surface 113 is described as pertaining to the front portion 109 and the side surface 122 is described as pertaining to the rear portion 110, the side surfaces 113, 122 may be a same surface extending between the front and rear portions 109, 110.

The adaptor 106 is preferably formed from a single metallic sheet metal such as a copper sheet; however, other electrically conductive metals or alloys may also be used. The adaptor 106 includes a front portion 125 having a pair of side walls 126, 127 configured to be positioned along the side surfaces 118, 119. A adaptor fastener opening 128 formed in each side wall 126, 127 allows the adaptor fastener 121 to secure the adaptor 106 to the rear portion 110. A rear portion 129 of the rear portion 110 includes a plurality of pins 130 securable and solderable to a printed circuit board (PCB) 131 (shown in phantom) to allow the terminal 103 to be electrically coupled to the PCB 131.

As illustrated in FIGS. 1-3, the pins 130 of the adaptors 106 extend from the rear portion 129 in an upward direction based on the orientation of the terminals 103 shown. However, the adaptors 106 are configurable to be installed in an opposition position such as that shown in FIG. 4, showing an orthogonal view of the pins in a downward direction. The reversible installation position of the adaptors 106 provides an increased flexibility in the installation options available for the terminal block 100.

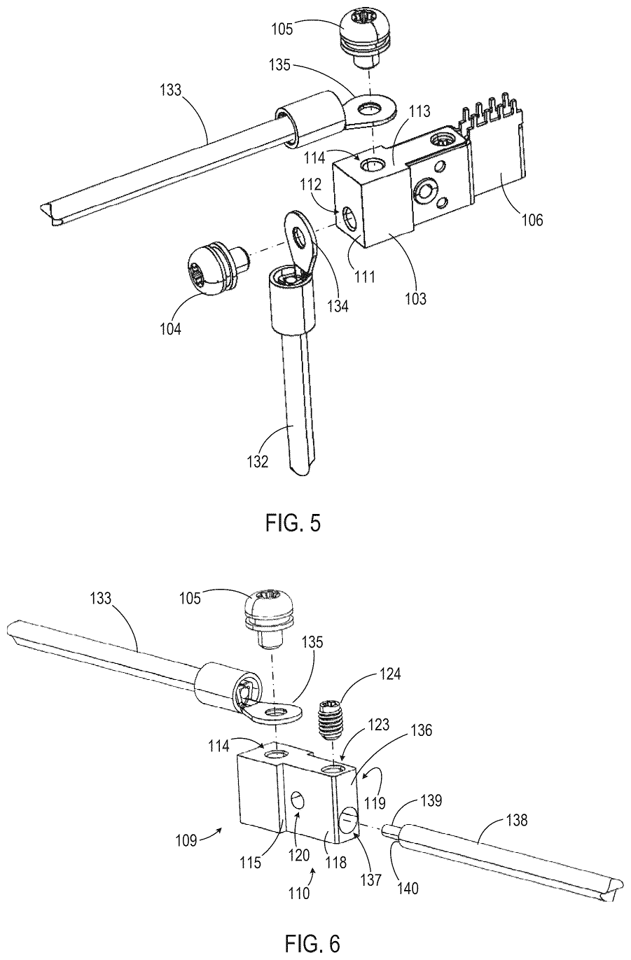

FIG. 5 is an exploded view illustrating wire connections to the terminal 103 according to an embodiment. By having the fastener openings 112, 114 in the front and side surfaces 111, 113, the terminal 103 is multi-directional and allows a wire 132 to be coupled with the terminal 103 via the wire fastener 104 and allows a wire 133 to be coupled with the terminal 103 via the wire fastener 105. In one embodiment, each of the wires 132, 133 may have a lug terminal 134, 135 coupled thereto to facilitate fastening of the wires 132, 133 by the wire fasteners, 104, 105. As illustrated the lug terminals 134, 135 may be ring-type terminals. However, other terminal types such as spade terminals may be used. Alternatively, no lug terminal may be used in one example of a bare section of the wires 132, 133 being exposed and engaged by the wire fasteners, 104, 105. Either or both of the wires 132, 133 may be coupled to the terminal 103, which, being electrically conductive, electrically couples the attached wires 132, 133 to the adaptor 106. When further coupled with a PCB (e.g., the PCB 131 of FIG. 3), the terminal 103 couples attached wires 132, 133 to the PCB.

FIG. 6 shows an exploded view illustrating wire connections to the terminal 103 according to another embodiment. In the embodiment illustrated, the adaptor 106 is not used. The rear portion 110 has a rear surface 136 having a wire opening 137 formed therein to allow insertion of a wire 138 therein. As shown, a bare end 139 of the wire having the insulation 140 removed therefrom is insertable in the wire opening 137, which communicates with the wire fastener opening 123. As such, insertion of the wire fastener 124 (e.g., a set screw) within the wire fastener opening 123 allows the wire fastener 124 to extend toward the bare end 139 sufficiently to secure the wire 138 against an inner wall of the wire opening 137. By coupling the wire 133 to the front portion 109 via the wire fastener 105 and coupling the wire 138 to the rear portion 110 via the wire fastener 124, the wires 133, 137 become electrically coupled together.

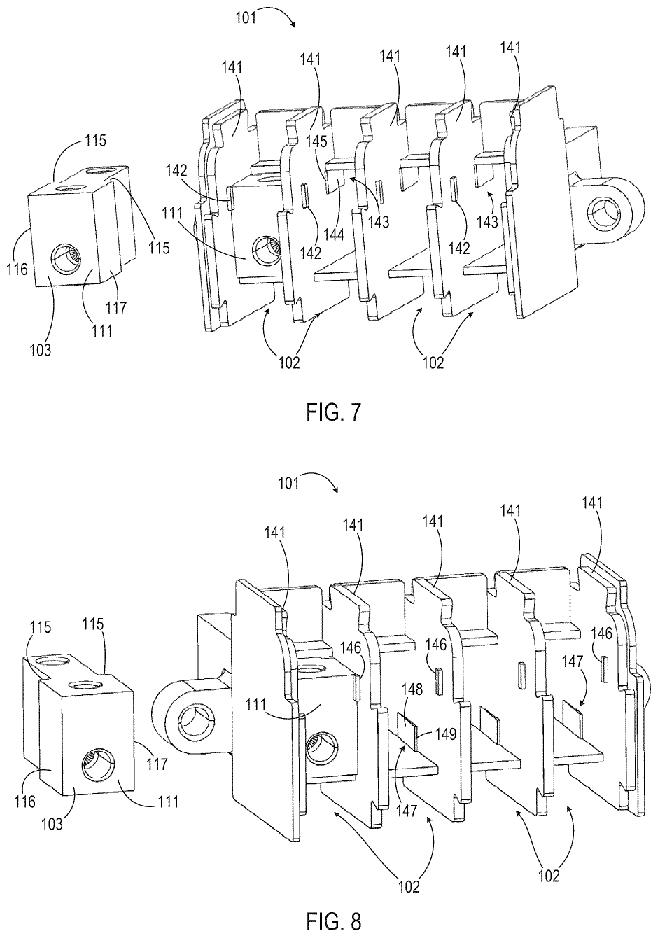

FIGS. 7 and 8 illustrate snap connections of the terminals 103 and housing 101 of the terminal block terminal block 100 according to an embodiment. FIGS. 7 and 8 show different views of the terminal housing 101 to illustrate features formed into the sides of some of the walls 141 of the terminal housing 101.

As shown in FIG. 7, a first side of the walls 141 includes an end stop 142 formed toward a front end of the terminal housing 101. The end stop 142 engages and abuts the front surface 111 of the terminal 103 when inserted into the respective terminal opening 102. The end stop 142 prevents the terminal 103 from extending beyond a desired installation position when inserted through a rear of the terminal housing 101 toward the front thereof. A ramp portion 143 extends from the wall 141 and includes a ramp 144 and an end wall 145. The ramp portion 143 is configured to engage the side surface 116 during insertion of the terminal 103 into the terminal opening 102. Once inserted, the end wall 145 of the ramp portion 143 engages or abuts the rear surface 115 of the terminal 103.

FIG. 8 shows a second side of the walls 141, which include another end stop 146 configured to engage or abut the front surface 111 of the terminal 103. Further, an additional ramp portion 147 having a ramp 148 and an end stop 149, the ramp 148 engaging the side surface 117 during installation of the terminal 103, and the end stop 149 engaging or abutting the rear surface 115 of the terminal 103 after insertion.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

1. A terminal block comprising:
a terminal housing comprising a plurality of walls forming a plurality of terminal openings; and
a plurality of terminals, each terminal positioned in a respective terminal opening of the plurality of terminal openings;
wherein each terminal of the plurality of terminals is electrically conductive and comprises:
a front portion comprising:
a front surface having a first fastener opening formed therein;
a first side surface having a second fastener opening formed therein;
a rear surface opposite the front surface;
a rear portion extending from the rear surface and having an adaptor fastener opening formed therein; and
an adaptor coupled to the rear portion via an adaptor fastener positioned within the adaptor fastener opening.

2. The terminal block of claim 1, wherein the rear portion further has a wire fastener opening formed in a first surface of the rear portion; and
wherein a rear surface of the rear portion has a wire opening formed therein communicating with the wire fastener opening.

3. The terminal block of claim 2 further comprising a wire fastener positioned within wire fastener opening and configured to secure a wire inserted within the wire opening against a wall of the wire opening.

4. The terminal block of claim 1 further comprising:
a first fastener inserted within the first fastener opening; and
a second fastener inserted within the second fastener opening.

5. The terminal block of claim 4, wherein the first and second fasteners comprise screws.

6. The terminal block of claim 1, wherein the adaptor is formed from a copper sheet.

7. The terminal block of claim 1, wherein the first side surface is orthogonal to the front surface.

8. The terminal block of claim 1, wherein each wall of a pair of walls of the plurality of walls forming a first terminal opening of the plurality of terminal openings comprises:
an end stop extending from the wall and configured to engage the front surface of the front portion of a respective terminal of the plurality of terminals; and
a ramp portion extending from the wall and configured to:
engage one of an opposite side surface of the front portion of the respective terminal during insertion of the respective terminal within the first terminal opening; and
engage the rear surface of the respective terminal after insertion of the respective terminal within the first terminal opening.

9. The terminal block of claim 1, wherein the adaptor comprises a solder pin configured to electrically couple the adaptor to a printed circuit board.

10. The terminal block of claim 1, wherein the adaptor fastener comprises a rivet.

11. A multi-position terminal block comprising:
a housing comprising a pair of openings formed via a plurality of walls;
a first terminal positioned in a first opening of the pair of openings; and
a second terminal positioned in a second opening of the pair of openings;
wherein each of the first and second terminals is electrically conductive and comprises:
a front portion comprising:
a front surface having a first fastener opening formed therein;
a first side surface having a second fastener opening formed therein; and
a rear surface opposite the front surface;
a rear portion extending from the rear surface and having a wire fastener opening formed in a first surface of the rear portion; and
wherein a rear surface of the rear portion has a wire opening formed therein communicating with the wire fastener opening.

12. The multi-position terminal block of claim 11, wherein the rear portion further has an adaptor fastener opening formed therein; and
further comprising an adaptor coupled to the rear portion via an adaptor fastener positioned within the adaptor fastener opening.

13. The multi-position terminal block of claim 11 further comprising a wire fastener positioned within the wire fastener opening;
wherein the wire fastener is configured to secure a wire inserted within the wire opening against a wall of the wire opening.

14. The multi-position terminal block of claim 13, wherein the wire fastener comprises a set screw.

15. The multi-position terminal block of claim 11 further comprising:
a first fastener inserted within the first fastener opening; and
a second fastener inserted within the second fastener opening.

16. A method of making a multi-position terminal block comprising:
forming a housing comprising a plurality of walls forming a plurality of terminal openings; and
inserting, into each of the terminal openings, a terminal comprising:
a front-facing surface having a first fastener opening formed therein;
a top-facing surface having a second fastener opening and a third fastener opening formed therein;
a first rear-facing surface opposite a first portion of the front-facing surface;
a second rear-facing surface opposite a second portion of the front-facing surface and having a wire opening formed therein communicating with the second fastener opening;
a first side-facing surface; and
a second side-facing surface opposite one another and having an adaptor fastener opening formed between the first and second side-facing surfaces.

17. The method of claim 16 further comprising inserting, into each of the front-facing surface and the top-facing surface, a wire fastener comprising a screw.

18. The method of claim 16 further comprising:
positioning an adaptor adjacently to the first and second side-facing surfaces; and
coupling the adaptor to the terminal via securing an adaptor fastener within the adaptor fastener opening.

19. The method of claim 18 further comprising forming the adaptor from a single piece of sheet metal, the adaptor comprising a solder pin configured to electrically couple the adaptor to a printed circuit board.

20. The method of claim 16, wherein forming the housing comprises forming, on a first wall of the plurality of walls:
an end stop configured to abut the front-facing surface; and
a ramp having an end wall configured to abut the first rear-facing surface.
